(19) United States
(12) Patent Application Publication
(10) Pub. No.: US 2025/0334968 A1
(43) Pub. Date: Oct. 30, 2025

(54) METHOD AND APPARATUS FOR PRODUCING HIGH-PRECISION INDOOR MAPS THROUGH LOOP CLOSING OPTIMIZATION

(71) Applicant: NATIONAL DISASTER MANAGEMENT RESEARCH INSTITUTE, Ulsan (KR)

(72) Inventors: Seong Sam Kim, Ulsan (KR); Jae-Wook Seok, Ulsan (KR); Yong-Han Jung, Ulsan (KR); Eon-Taek Lim, Ulsan (KR); Seul Koo, Ulsan (KR); Cheol Kyu Lee, Ulsan (KR)

(21) Appl. No.: 19/184,350

(22) Filed: Apr. 21, 2025

(30) Foreign Application Priority Data
Apr. 24, 2024 (KR) 10-2024-0054809

(51) Int. Cl. G05D 1/246; G05D 1/622; G05D 1/644; G05D 105/80; G05D 109/10; G05D 111/10; G05D 111/50

(52) U.S. Cl. CPC G05D 1/246; G05D 1/622; G05D 1/644; G05D 2105/87; G05D 2109/10; G05D 2111/17; G05D 2111/52; G05D 2111/54

(57) ABSTRACT

The present disclosure relates to an operation method of a computing device for performing a method for producing precise indoor maps using loop closing, including the steps of moving a robot to a first location, wherein the robot collects images and sensor data for precise map production by using a sensor module including at least one of a LiDAR sensor, an IMU sensor; forming a first closed-loop trajectory with an optimized pose graph by odometry estimation from the first location to create a first map using the movement of the robot; updating at least part of a second map generation trajectory and sensor data corresponding to a current trajectory of the robot by using at least one of trajectory information and sensor data of the first closed-loop trajectory; and outputting an updated second map based on the updated second map generation trajectory and sensor data.

### CROSS-REFERENCE TO RELATED APPLICATION

This application claims priority to Korean Patent Application No. 10-2024-0054809, filed on Apr. 24, 2024, and all the benefits accruing therefrom under 35 U.S.C. § 119, the contents of which in its entirety are herein incorporated by reference.

### BACKGROUND

### 1. Field

Embodiments of the present disclosure relate to a method and apparatus for creating high-precision indoor maps through loop closing optimization, and more particularly, to a map creation method and apparatus with improved precision of indoor maps by using loop closing to produce the indoor maps using images and LiDAR.

### 2. Description of the Related Art

A mobile robot is required to locate itself in a given environment, and when placed in an unexperienced new environment, to make a map of the surrounding area itself.

Robotic mapping refers to a task of finding locations at which nearby obstacles or objects are placed and open spaces where the mobile robot can move freely, and memorizing them by a proper method.

As an example of the robotic mapping technology, Korean Patent Publication No. 10-2010-0070922 (published on Jun. 28, 2010) discloses creating a grid map using distance information to a nearby object, and associating with landmark location information to create a final grid map for location recognition of the mobile robot.

In particular, in the process of odometry (a relative movement trajectory of the mobile robot) estimation and trajectory optimization, a one-way open loop method that produces indoor maps while randomly moving in a predefined space or moving in a manner of avoiding previously visited areas is generally used.

However, in sites where situations may change, for example, disaster sites, when local maps are not optimized and replaced, errors may accumulate over and over, causing errors in precise map creation.

### RELATED LITERATURES

### Patent Literatures

(Patent Literature 1) Korean Patent Publication No. 1020180109410 (2018 Oct. 8 ) [Applicant: NAVER CORPORATION]

### SUMMARY

The present disclosure is designed to solve the above-described problems, and therefore the present disclosure is directed to providing a method and apparatus for producing high-precision indoor maps through loop closing optimization for creating maps with minimized errors and higher precision by improving odometry estimation and trajectory optimization of the current trajectory by using a closed-loop trajectory formed by a previously visited trajectory.

The problems to be solved are not limited to the above-described problems, and may be expanded to various problems that may be derived by the embodiments of the present disclosure described below.

The present invention relates to a method, a computer-readable program, and a computing device for generating a refined indoor map using loop closure techniques, in which pose graph optimization and condition-based loop route selection are employed to improve the mapping accuracy and robustness in complex indoor environments.

According to one aspect of the invention, there is provided a method for refining an indoor map using loop closure, performed by a computing device. The method includes moving a robot, equipped with a sensor module comprising at least one of a LiDAR sensor, an Inertial Measurement Unit (IMU) sensor, or one or more vision sensors, to a first location for collecting image and sensor data for precise map generation. A first loop closure route is formed for first map generation based on odometry estimation from the first location and optimized via a pose graph. The method further includes updating a second map generation route and at least a part of the corresponding sensor data using at least one of the route information and sensor data of the first loop closure route. A second map is then output based on the updated route and data.

The method further includes setting condition information for the first loop closure route corresponding to the first location. The condition information includes a condition for selecting a returnable point among surrounding positions as the first location, based on at least one of: floor condition information acquired from the robot's sensor data, the presence of two or more available passages for robot movement, and slope information.

If returning to the first location becomes infeasible due to obstacles or structural changes, the condition information further includes relative location data with respect to the first location and a condition for determining a second location adjacent within a preset distance as a substitute endpoint of the first loop closure route. In this case, a second map generation route is determined as a second loop closure route connecting the first and second locations.

During the update process, even when the robot moves along the second loop closure route, the system performs an indoor map update using previously collected image and sensor data from at least a portion of the first loop closure route (i.e., between departure from and return to the first location).

In certain embodiments, the update step further comprises performing pose graph optimization for the second map generation route using at least one of the route information or sensor data of the first loop closure route. The method may also include updating local map information and odometry estimation corresponding to the robot's current route, based on the updated local map information obtained from the pose graph optimization.

In one embodiment, the pose graph optimization of the second map generation route includes both loop closure optimization for optimizing the robot's entire route and smoothing optimization for re-optimizing at least part of the previously traversed route based on accumulated sensor data.

In another embodiment, the returnable point is determined based on all three criteria: floor condition data, availability of at least two movable passages, and slope information.

In addition, the condition information may include a condition in which the first location is defined as a specific area within a predetermined proximity range, based on location information of a uniquely identifiable object in the surrounding visual data.

The second location, when selected as the substitute endpoint, is determined such that the environment of the first location is still included in the peripheral video collected by the robot at the second location, thereby enabling relative difference compensation between the two locations.

According to another aspect of the invention, a computer-readable medium stores a computer program configured to cause a computer to perform any of the methods described above.

According to yet another aspect of the invention, a computing device for generating a refined indoor map using loop closure is provided. The computing device includes a robot driving unit and a precise map generation unit. The robot driving unit moves a robot to a first location using a sensor module that includes at least one of a LiDAR sensor, an IMU sensor, or one or more vision sensors for collecting image and sensor data for precise map generation. The precise map generation unit performs the following: forming a first loop closure route optimized through pose graph estimation based on odometry from the first location; updating a second map generation route and at least part of its sensor data using at least one of the route information and sensor data of the first loop closure route; and outputting an updated second map based on the updated route and data.

The robot driving unit is configured to set condition information for the first loop closure route corresponding to the first location. The condition information includes: selecting a returnable point among surrounding positions as the first location based on at least one of floor condition data, availability of at least two movable passages, and slope information. It also includes determining the first location as a specific area within a predetermined proximity range based on the location of uniquely identifiable objects in the surrounding image.

When return to the first location is impossible due to obstacles or structural changes, the condition information includes relative position data and a condition for selecting a second location, within a certain distance, as a substitute endpoint of the first loop closure route. If the second location is so determined, the pose graph optimizer is configured to define a second map generation route as a second loop closure route connecting the first and second locations.

Even when the robot follows the second loop closure route, the precise map generation unit updates the indoor map using previously collected data corresponding to at least part of the original first loop closure route (between departure from and return to the first location). The second location is selected so that the peripheral video collected by the robot for map generation includes the environment of the first location, enabling compensation for relative differences.

The computing device further includes a pose graph optimizer configured to perform pose graph optimization for the second map generation route using at least one of the route information and sensor data of the first loop closure route, and an odometry estimator configured to update the local map and odometry estimation based on the updated local map information.

According to an embodiment of the present disclosure, to produce the first map, the first closed-loop trajectory with the optimized pose graph may be formed by odometry estimation from the first location, at least part of the second map generation trajectory and sensor data corresponding to the current trajectory of the robot may be updated using at least one of the trajectory information and sensor data of the first closed-loop trajectory, and the updated second map may be formed based on the updated second map generation trajectory and sensor data.

Accordingly, the present disclosure may provide the method and apparatus for producing high-precision indoor maps through loop closing optimization to create maps with minimized errors and higher precision by improving odometry estimation and trajectory optimization of the current trajectory by using the closed-loop trajectory formed by the previously visited trajectory.

It should be understood that the effects of the present disclosure are not limited to the above-described effects, and may be expanded to various effects that may be derived from the following detailed description of the embodiments of the present disclosure.

### BRIEF DESCRIPTION OF THE DRAWINGS

FIG. 1 is a diagram showing an example of an operating environment of a system according to an embodiment of the present disclosure.

FIG. 2 is a block diagram illustrating the internal configuration of a computing device 200 according to an embodiment of the present disclosure.

FIG. 3 is a diagram illustrating the hardware configuration of an investigation robot connected to a computing device according to an embodiment of the present disclosure.

FIG. 4 is an exemplary diagram illustrating a sensor module mounted on a robot (300) according to an embodiment of the present invention, wherein the multi-sensor (320) is shown in hardware configuration.

FIG. 5 is a block diagram illustrating in greater detail a service processing unit (250) of a computing device (200) configured to operate the robot (300) and output facility analysis information corresponding to three-dimensional analysis of indoor and outdoor spaces, according to an embodiment of the present invention.

FIG. 6 is a flowchart illustrating a loop closure-based path optimization process for indoor map refinement according to an embodiment of the present invention.

FIGS. 7 and 8 are exemplary diagrams illustrating path optimization according to an embodiment of the present invention.

FIG. 9 is a diagram showing the results of an accuracy test experiment using an embodiment of the present invention.

### DETAILED DESCRIPTION

In describing an embodiment of the present disclosure, when a certain detailed description of well-known elements or functions is determined to make the subject matter of an embodiment of the present disclosure ambiguous, the detailed description is omitted. Additionally, in the drawings, elements irrelevant to the description of an embodiment of the present disclosure are omitted, and like reference signs are affixed to like elements.

In an embodiment of the present disclosure, when an element is referred to as being “connected”, “coupled” or “linked” to another element, this may include not only a direct connection relationship but also an indirect connection relationship in which intervening elements are present. Additionally, unless expressly stated to the contrary, “comprise” or “include” when used in this specification, specifies the presence of stated elements but does not preclude the presence or addition of one or more other elements.

In an embodiment of the present disclosure, the terms “first”, “second” and the like are used to distinguish an element from another, and do not limit the order or importance between elements unless otherwise mentioned. Accordingly, a first element in an embodiment may be referred to as a second element in other element within the scope of embodiments of the present disclosure, and likewise, a second element in an embodiment may be referred to as a first element in other embodiment.

In an embodiment of the present disclosure, the distinguishable elements are intended to clearly describe the feature of each element, and do not necessarily represent the separated elements. That is, a plurality of elements may be integrated into one hardware or software, and an element may be distributed to multiple hardware or software. Accordingly, although not explicitly mentioned, the integrated or distributed embodiment is included in the scope of embodiments of the present disclosure.

In the specification, a network may be a concept including a wired network and a wireless network. In this instance, the network may refer to a communication network that allows data exchange between a device and a system and between devices, and is not limited to a particular network.

The embodiment described herein may have aspects of entirely hardware, partly hardware and partly software, or entirely software. In the specification, “unit”, “apparatus” or “system” refers to a computer related entity such as hardware, a combination of hardware and software, or software. For example, the unit, module, apparatus or system as used herein may be a process being executed, a processor, an object, an executable, a thread of execution, a program and/or a computer, but is not limited thereto. For example, both an application running on a computer and the computer may correspond to the unit, module, apparatus or system used herein.

Additionally, the device as used herein may be a mobile device such as a smartphone, a tablet PC, a wearable device and a Head Mounted Display (HMD) as well as a fixed device such as a PC or an electronic device having a display function. Additionally, for example, the device may be an automotive cluster or an Internet of Things (IoT) device. That is, the device as used herein may refer to devices on which the application can run, and is not limited to a particular type. In the following description, for convenience of description, a device on which the application runs is referred to as the device.

In the present disclosure, there is no limitation in the communication method of the network, and a connection between each element may not be made by the same network method. The network may include a communication method using a communication network (for example, a mobile communication network, a wired Internet, a wireless Internet, a broadcast network, a satellite network, etc.) as well as near-field wireless communication between devices. For example, the network may include all communication methods that enable networking between objects, and is not limited to wired communication, wireless communication, 3G, 4G, 5G, or any other methods. For example, the wired and/or wireless network may refer to a communication network by at least one communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VOIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) or communication using ultrasonic waves, but is not limited thereto.

The elements described in a variety of embodiments are not necessarily essential, and some elements may be optional. Accordingly, an embodiment including some of the elements described in the embodiment is also included in the scope of embodiments of the present disclosure. Additionally, in addition to the elements described in a variety of embodiments, an embodiment further including other elements is also included in the scope of embodiments of the present disclosure.

Hereinafter, embodiments of the present disclosure will be described in detail with reference to the accompanying drawings.

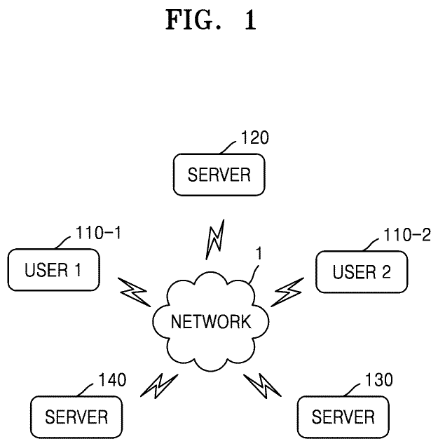

FIG. 1 is a diagram showing an example of a working environment of a system according to an embodiment of the present disclosure. Referring to FIG. 1, a user device 110 and one or more servers 120, 130, 140 are connected via a network 1. FIG. 1 is provided by way of example, and the number of user devices or servers is not limited thereto.

The user device 110 may be a fixed or mobile terminal implemented as a computer system. The user device 110 may include, for example, a smart phone, a mobile phone, a navigation, a computer, a laptop computer, a digital broadcasting terminal, a Personal Digital Assistant (PDA), a Portable Multimedia Player (PMP), a tablet PC, a game console, a wearable device, an internet of things (IoT) device, a virtual reality (VR) device and an augmented reality (AR) device. For example, in the embodiments, the user device 110 may refer to, in substance, one of a variety of physical computer systems that can communicate with the servers 120-140 via the network 1 using a wireless or wired communication method.

Each server may be implemented as a computer device or a plurality of computer devices which provide instructions, code, files, content and services by communication with the user device 110 via the network 1. For example, the server may be a system which provides each service to the user device 110 connected via the network 1. As a more specific example, through an application as a computer program installed and running on the user device 110, the server may provide the user device 110 with a service (for example, information provision, etc.) intended by the corresponding application. As another example, the server may distribute files for installing and running the above-described application to the user device 110, receive user input information and provide a corresponding service.

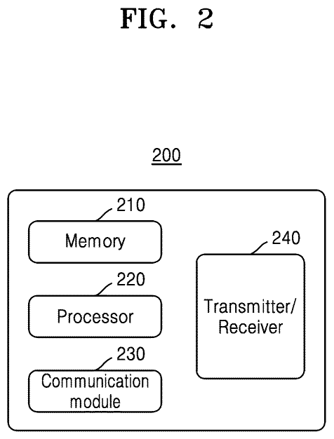

FIG. 2 is a block diagram illustrating the internal configuration of a computing device 200 in an embodiment of the present disclosure. The computing device 200 may be applied to the user device 110 or the servers 120-140 described above with reference to FIG. 1, and each device and the servers may have identical or similar internal configuration by adding or subtracting some components.

Referring to FIG. 2, the computing device 200 may include a memory 210, a processor 220, a communication module 230 and a transmitter/receiver 240. The memory 210 is a non-transitory computer-readable recording medium, and may include a permanent mass storage device such as random access memory (RAM), read only memory (ROM), disk drive, solid state drive (SSD) and flash memory. Here, the permanent mass storage device such as ROM, SSD, flash memory and disk drive is a separate permanent storage device that is different from the memory 210 and may be included in the above-described device or server. Additionally, the memory 210 may store an operating system and at least one program code (for example, code for browsers installed and running on the user device 110 or applications installed on the user device 110 to provide particular services). These software components may be loaded from a separate computer-readable recording medium that is different from the memory 210. The separate computer-readable recording medium may include a computer-readable recording medium such as floppy drive, disk, tape, DVD/CD-ROM drive and a memory card.

In another embodiment, the software components may be loaded onto the memory 210 through the communication module 230, but not the computer-readable recording medium. For example, at least one program may be loaded onto the memory 210 based on a computer program (for example, the above-described application) installed by files provided by developers or a file distribution system (for example, the above-described server) responsible for distributing an installation file of the application via the network 1.

The processor 220 may be configured to process the instructions of the computer program by performing basic operations such as arithmetic, logic and input/output operations. The instructions may be provided to the processor 220 by the memory 210 or the communication module 230. For example, the processor 220 may be configured to execute the received instructions according to the program code stored in the recording device such as the memory 210.

The communication module 230 may provide a function of allowing the user device 110 and the servers 120-140 to communicate with each other via the network 1, and a function of allowing each of the device 110 and/or the servers 120-140 to communicate with another electronic device.

The transmitter/receiver 240 may be a means for interfacing with an external input/output device (not shown). For example, the external input device may include a keyboard, a mouse, a microphone and a camera, and the external output device may include a display, a speaker and a haptic feedback device.

As another example, the transmitter/receiver 240 may be a means for interfacing with a device having an integrated function for input and output such as a touchscreen.

Additionally, in other embodiments, the computing device 200 may include a larger number of components than the components of FIG. 2 according to the nature of a device to which the computing device 200 is applied. For example, when the computing device 200 is applied to the user device 110, the computing device 200 may be implemented to include at least some of the above-described input/output devices, or may further include other components such as a transceiver, a Global Navigation Satellite System (GNSS) module, a camera, a variety of sensors and a database. As a more specific example, when the user device is a smartphone, the computing device 200 may be implemented to further include various types of components commonly included in smartphones, such as an acceleration sensor or a gyro sensor, a camera module, a variety of physical buttons, buttons using a touch panel, input/output ports and a vibrator for vibration.

The computing device 200 described above may be realized by a device including a processor and a memory. The memory may store instructions, and the processor may perform the operations described hereinafter based on the instructions stored in the memory. The device according to the present disclosure may be implemented by at least a part of the configuration illustrated in FIG. 1 or FIG. 2.

Hereinafter, the operation of a computing device will be described with reference to FIGS. 1 and 2. As an example, hereinafter, a user may communicate with a robot 300 based on the computing device 200. In addition, hereinafter, the robot 300 may be a device connected to one computing device 200 to communicate with an external device. As a specific example, the robot 300 may communicate with another device or a server via a network, and include the components of the computing device 200 of FIG. 2. In addition, the robot 300 may include a sensor to identify a surrounding image or video, and it will be described below.

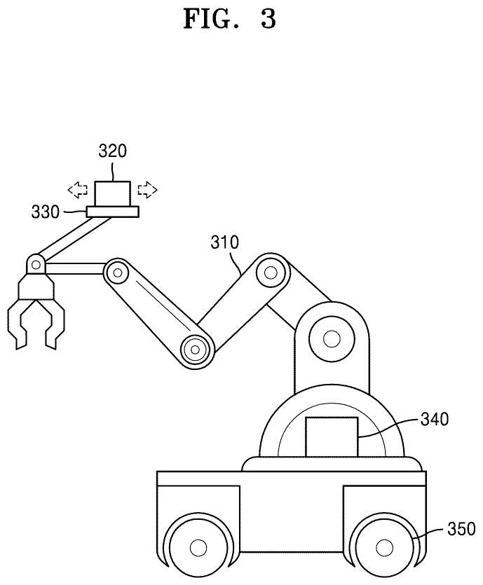

FIG. 3 is a diagram illustrating the hardware configuration of the investigation robot connected to the computing device according to an embodiment of the present disclosure.

Referring to FIG. 3, the robot 300 may include a multisensor 320 including at least one sensor, a header 330 capable of fine adjustment and light source formation and used to couple the multisensor 320, and a robot arm 310 to which the multisensor 320 is connected by a connector means, and may be configured to perform indoor structure analysis.

Here, the robot arm 310 may be designed to rotate 360° and may be folded and extended.

In addition, the robot 300 may include, at the lower part, a control unit 340 to control the hardware of the robot and power and communication, and a movement unit 350 to control the movement means during movement, so as to make a movement for structure damage analysis in indoor environments in the event of disasters. For example, the movement unit 350 may include wheels or any other component that performs the function of moving in indoor/outdoor spaces, and is not limited to a particular type.

As described above, the robot 300 may be configured to move in indoor/outdoor spaces, and have a communication function to collect various information and transmit it to another device or a server. In addition, the robot 300 may include the multisensor 320 to acquire sensing information. Here, the multisensor 320 may include a LiDAR sensor, an Inertial Measurement Unit (IMU) sensor, a vision camera, a depth camera, a gyro sensor and any other sensors for sensing surrounding information, and is not limited to a particular sensor.

The LiDAR sensor may be a sensor that measures reflector location coordinates by sending a laser pulse and measuring the time taken for the pulse to reflect and return. In addition, the IMU sensor may be a motion sensor that measures the orientation, acceleration and position of a device by measuring the speed, direction and magnetic field through a speedometer, a gyroscope and a magnetometer. In addition, the vision camera may sense image information of surrounding images, and the depth camera may be a sensor that measures or senses 3-dimensional (3D) images (i.e., depth images) of nearby objects based on stereo vision or time of flight (ToF). Other sensors may include sensors for sensing temperature, air pressure and surroundings, and are not limited to a particular embodiment.

As an example, the robot 300 may include the LiDAR sensor (or module) for indoor positioning and mapping. Here, the LiDAR sensor may be made in a small size and coupled to the robot 300. In particular, the LiDAR sensor may work based on Simultaneous Localization And Mapping (SLAM) to produce indoor maps in real time, thereby enabling indoor structure recognition.

In addition, as an example, a global navigation satellite system (GNSS) may be used for indoor/outdoor positioning at disaster sites. However, in disaster sites where indoor communication and radio wave connection from the outside fails due to building shielding and damage, self-positioning and mapping in indoor/outdoor spaces is necessary, and to this end, the robot 300 may include the camera and the LiDAR sensor as the multisensor 320. In this instance, as an example, because of measuring the time based on ToF, the LiDAR sensor may be sensitive to vibration caused by external factors. In view of this fact, the multisensor 320 may include the IMU sensor to sense movement and vibration values of the robot 300 that in turn, moves the position, taking vibration and analysis accuracy into account, thereby achieving stable crack detection and damage information analysis.

As described above, the multisensor 320 may include the sensors to help the robot 300 perform sensing in indoor structures collapsed by earthquake, and the sensing information is not limited to a particular embodiment. For convenience of description, the following description is based on the sensing operation through the multisensor 320 coupled to the robot 300 for the robot 300 to analyze indoor structures. That is, the robot 300 described below may be the robot 300 including the multisensor 320, and may not be limited to a particular embodiment.

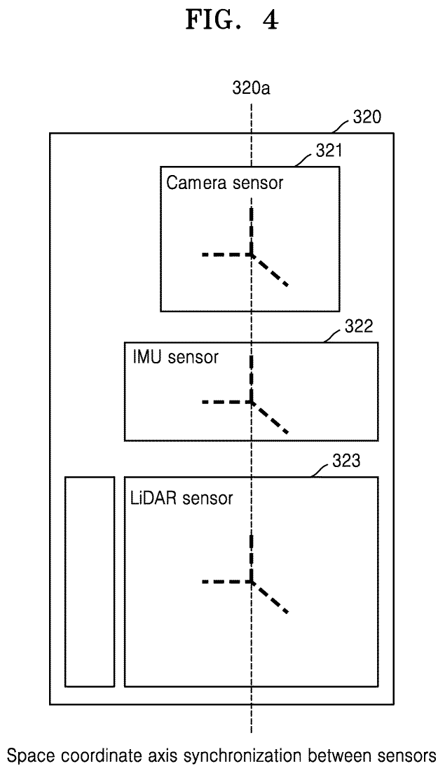

FIG. 4 is an exemplary diagram of the sensor module mounted on the robot 300 according to an embodiment of the present disclosure, showing the hardware configuration of the multisensor 320.

Referring to FIG. 4, the multisensor 320 according to an embodiment of the present disclosure may include the camera sensor 321 on top, the IMU sensor 322 axially coupled to the bottom of the camera sensor 321 and the LiDAR sensor 323 axially coupled to the bottom of the IMU sensor 322.

Here, each sensor module of the multisensor 320 may be physically coupled to each other with respect to a main axis 320a that vertically passes through each module to synchronize 3D space sensing coordinate axes.

By the coordinate axis synchronization of the multisensor 320, as the robot 300 moves and climbs slopes, positioning and rotation information may be processed in real time and reflected in the acquired sensing information of the multisensor 320. For example, the output of each sensor module acquired by the coordinate axis synchronization may be mapped to position information with respect to the synchronized main coordinate axis information, and the image information, the depth sensing information, the rotation information, the angle information, the acceleration information and the vibration information acquired in synchronization from each sensor module may be mapped to the position information and used to track the position of the robot 300 and detect damage to facilities in indoor/outdoor spaces.

In addition, to ease the sensing information processing of the multisensor 320, it is preferable to use SLAM-based data processing. The SLAM is a technology that estimates a location using various sensors in an unknown environment and produces a 3D map of the environment, and has a wide range of applications with increasing computer processing speed and development of sensor technology such as camera and LiDAR, and is used for indoor positioning and mapping, especially when there are no prior maps at disaster sites, to create spatial information through LiDAR and camera-based scanning, data structuring and 3D indoor map visualization.

Accordingly, the robot 300 may build a 3D indoor map by the processing of the sensing information from the multisensor 320 into data, then detect assumed facilities in the indoor map and the degree of damage for each facility based on crack analysis and share the same. For example, the robot 300 may move into an indoor structure collapsed by earthquake, create spatial information based on the robot's location in the structure, and analyze and output the degree of damage for each facility.

In this instance, the indoor structure collapsed by earthquake may be, for example, a harsh environment, and the sensing accuracy may be increased by using data in the preset harsh condition as described below. That is, given the environment of the indoor structure collapsed by earthquake, the robot 300 may perform sensing through the sensors while moving indoors. Here, the harsh condition may include, for example, conditions classified into flat ground, speed bumps and gravel, detected by average acceleration and maximum acceleration sensing.

The robot 300 and the multisensor 320 may be controlled by the computing device 200 according to an embodiment of the present disclosure. As an example, the robot 300 may perform indoor positioning and mapping and damage analysis using SLAM based on the multisensor 320, and the robot 300 may be controlled by the connected computing device 200. As an example, the robot 300 and the computing device 200 may exchange information through communication connection between them. In this instance, the robot 300 may perform sensing in indoor/outdoor spaces based on the control operation of the computing device 200, and the computing device 200 may control the position of the multisensor 320 or the movement of the movement unit 350 in real time to increase the accuracy of crack detection.

For example, vibration for sensitivity of the LiDAR sensor or light source environment for image capture of the camera may differ depending on situations at disaster sites. Accordingly, distortion may occur in the sensing information, and a variety of computing processes for minimizing the distortion may be processed by the computing device 200 into a control signal for the robot 300.

As an example, indoor positioning and rotation of the multisensor 320 equipped in the robot 300 may be controlled by the operation control of the robot arm 310 by the computing device 200.

In addition, as an example, the computing device 200 may play a role in controlling the operation of the header 330 coupled to the multisensor 320 to achieve more accurate sensing operation by fine adjustment to the position of the sensor modules of the multisensor 320 and light source control of light-emitting diode (LED) light attached to the header 330.

Further, the computing device 200 may control the movement location and speed of the robot 300, and the movement location and speed may be optimized to prevent distortion or errors, taking into account the vibration sensing and the recognition rate of the vision sensor with changes in indoor environments.

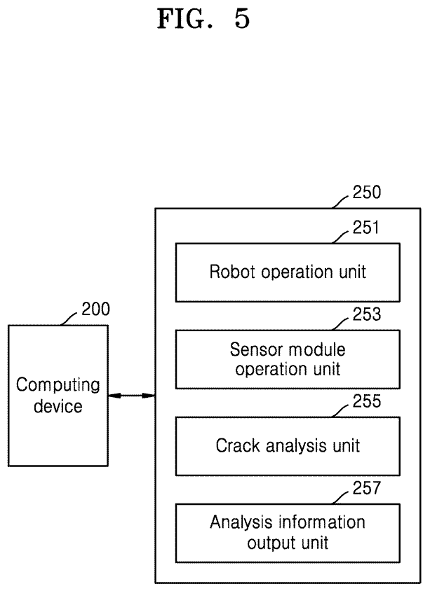

FIG. 5 is a detailed block diagram showing a service processing unit 250 of the computing device 200 for outputting facility analysis information corresponding to indoor/outdoor space 3D analysis by the operation of the robot 300 according to an embodiment of the present disclosure.

Referring to FIG. 5, the computing device 200 according to an embodiment of the present disclosure may further include the service processing unit 250. The service processing unit 250 may include processor modules to perform a variety of service processes for robot 300 control data processing according to an embodiment of the present disclosure among logic and input/output processing of a processor 220. The computing device 200 may perform service processing by including the service processing unit 250 within the processor 220 or using processed data from a device including the service processing unit 250 as an external processor, and provide the produced service processing result to a user device 110 or one or more servers 120, 130, 140.

By the above-described processing, the user device 110 or one or more servers 120, 130, 140 may receive the analysis information formed by the operation of the service processing unit 250 according to an embodiment of the present disclosure and display and output it through a display device or use it to transmit and receive data via an external network.

More specifically, referring to FIG. 5, the service processing unit 250 includes a robot operation unit 251, an odometry estimation unit 253, a pose graph optimization unit 255 and a precision map creation unit 257.

The robot operation unit 251 generates the control signal for controlling the hardware operation to control the position movement and sensing operation of the robot 300 shown in

FIGS. 3 and 4 described above, transmits the control signal to the robot 300, and controls the operation in response to the received response.

Here, the robot operation unit 251 may control the operation of each of the multisensor 320, the header 330, the robot arm 310, the control unit 340 and the movement unit 350 of the robot 300, thereby controlling the movement of the robot 300 and indoor positioning and sensing of the multisensor 320.

In addition, the robot operation unit 251 acquires the sensor signal from each sensor of the multisensor 320, performs SLAM-based processing into the synchronized sensing information for each location and transmits it to the odometry estimation unit 253.

Here, the sensor signal may include the sensor signal from the LiDAR sensor 323, the sensor signal from the IMU sensor 322 and the vision sensing signal from the camera sensor 321. In addition, the sensor module operation unit 253 may perform mapping and conversion processing of the signal acquired from each sensor module of the multisensor 320 into SLAM data, and the SLAM data may be transmitted to the odometry estimation unit 253.

Here, in addition to the basic sensor signals from the LiDAR sensor 323, the IMU sensor 322 and the camera sensor 321, the SLAM data may further include information that has undergone conversion processing into 3D spatial data.

For example, the SLAM data may further include indoor location coordinate information calculated from the IMU sensor 322, a raw image mapping image acquired from the camera sensor 321, pose information of the camera and the LiDAR calculated by the IMU sensor 322, and feature point cloud information acquired from the raw image.

In addition, when the sensing accuracy of each sensor information is below a threshold, in order to improve the sensing accuracy, the robot operation unit 251 may request the robot 300 to move the position or control accurate positioning of the multisensor 320.

Meanwhile, the odometry estimation unit 253 performs odometry estimation to estimate the relative movement distance and direction of the robot 300 from the initial location, from the sensor data transmitted from the robot operation unit 251.

In particular, according to an embodiment of the present disclosure, the odometry estimation unit 253 may acquire movement state information of the robot 300 based on at least one tracked closed-loop trajectory information, map the acquired movement state information and key frame scan information of the SLAM or IMU data together and transmit it to the pose graph optimization unit 255.

Meanwhile, when the movement state information is acquired, the pose graph optimization unit 255 may perform primary optimization using the at least one tracked closed-loop trajectory information corresponding to at least part of the entire closed-loop movement trajectory of the robot 300, and secondary optimization using the currently collected key frame scan information and IMU data, thereby performing trajectory smoothing together with pose graph optimization (PGO) for more accurate positioning.

Subsequently, the odometry estimation unit 253 acquires the state information and local map information update information received from the pose graph optimization unit 255, updates odometry information based on the same, and continuously collects the movement state information of the robot 300 based on the same.

In addition, the precision map creation unit 257 forms precision map information based on the acquired key frame scan information corresponding to the optimized trajectory from the pose graph optimization unit 255 and the state information of the robot 300, and outputs the precision map information through an output device or one or more devices 110.

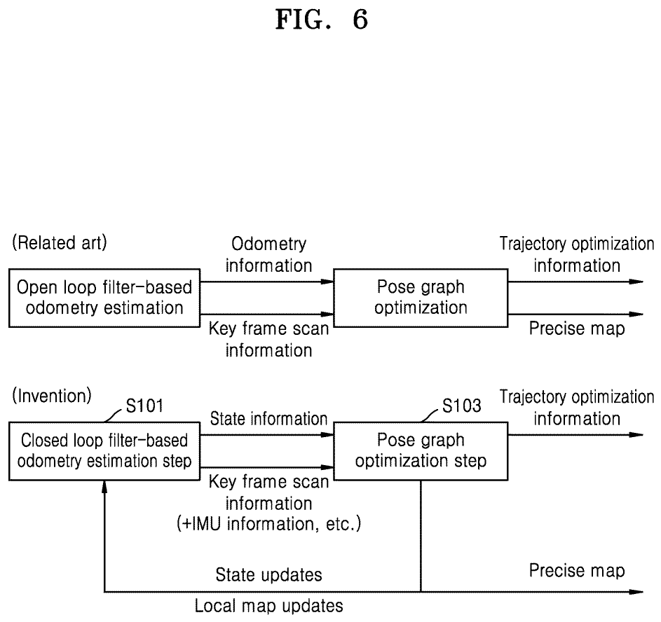

FIG. 6 is a flowchart illustrating the trajectory optimization process based on the closed-loop trajectory for improving indoor map precision according to an embodiment of the present disclosure.

As shown in FIG. 6, in the robot-based mapping, the existing techniques perform odometry estimation using an open loop filter to allow the robot to move along an open, fixed or randomly optimized trajectory to avoid a previously visited location in order to maximize only the trajectory for map production.

However, it is an inefficient process in sites where local maps may change dynamically, such as disaster sites. In particular, when partial errors accumulate, the error accumulation may lead to inefficient trajectories or cause errors in precise map production.

Accordingly, the odometry estimation unit 253 according to an embodiment of the present disclosure may form the closed-loop trajectory by initial odometry tracking, and subsequently, perform closed loop filter-based odometry estimation on at least part of the trajectory using the information collected from the closed-loop trajectory (S101).

Subsequently, the pose graph optimization unit 255 may perform pose graph optimization using the state information and key frame scan information acquired by the closed loop filter-based odometry estimation (S103).

For example, the pose graph optimization unit 255 may perform loop closing optimization to optimize the entire trajectory of the robot 300 when the trajectory of the robot draws a closed curve after the initial odometry estimation (when the robot revisits a previously visited location), and update optimization information through smoothing optimization to re-optimize at least part of the visited trajectory with the information collected so far, in order to achieve more accurate positioning despite local dynamic changes in the map.

This may solve the error accumulation issue of the odometry and optimization process caused by the non-feedback one-way open loop method that does not replace local maps with pose graph optimized maps, and provide the precision error-free pipeline by transmitting a part of the optimized map in the prior closed-loop trajectory and the current state to the odometry estimation unit 253, thereby achieving trajectory optimization for more precise map production.

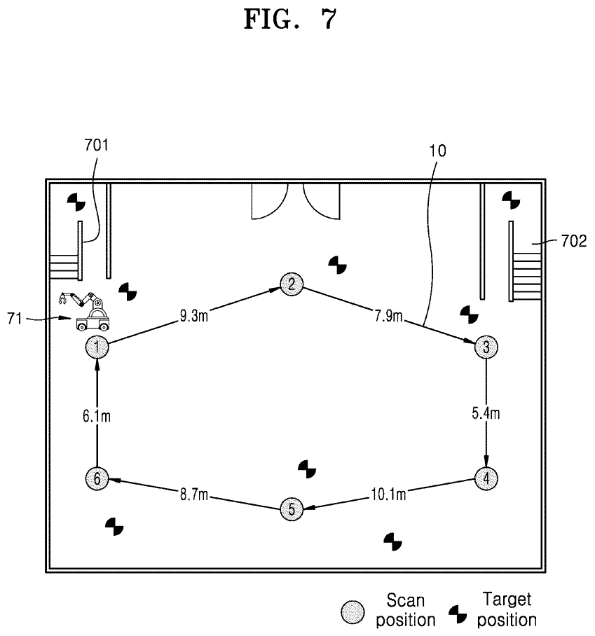

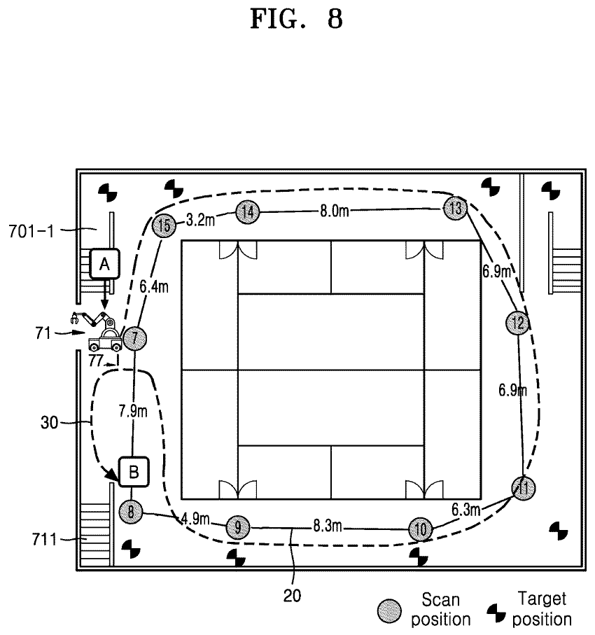

FIGS. 7 and 8 are exemplary diagrams illustrating trajectory optimization according to an embodiment of the present disclosure.

Referring to FIGS. 7 and 8, in FIG. 7, the first closed-loop trajectory 10 formed by the initial odometry is indicated by the solid line (indicated by the arrow), and the second closed-loop trajectory 20 updated by the trajectory optimization based on the first closed-loop trajectory 10 is indicated by the dotted line.

As described above, the pose graph optimization unit 255 according to an embodiment of the present disclosure may be configured to acquire, from the odometry estimation unit 253, the closed-loop trajectory information of at least part of the movement trajectory of the robot 300 as the first closed-loop trajectory 10, and when generating the second closed-loop trajectory 20, to update the map information collected along the first closed-loop trajectory 10 in the subsequent movement trajectory based on the map between the start point and the end point of the first closed-loop trajectory 10.

Because the absolute coordinates of the robot 300 are usually unknown in the indoor space, the odometry estimation unit 253 produces the map of the indoor space by combining surrounding images continuously captured during the relative movement, but due to the characteristics of the disaster site, errors may occur due to the movement and posture change of the robot 300 and the measurement environment may also change dynamically.

Accordingly, for example, the pose graph optimization unit 255 according to an embodiment of the present disclosure may set the start point A for creating the first closed-loop trajectory 10, and on the premise that the surrounding images and sensor data acquired by the robot 300 at the point A are identical to the surrounding images and sensor data acquired after the robot returns to the point A, store and manage the surrounding images and sensor data collected in the first closed loop 10, and perform sensor data correction and optimization using the information of the first closed loop 10 when performing optimization of the second closed loop 20.

Here, the pose graph optimization unit 255 may preset condition information for setting the start point A. The start point A may be determined based on the surrounding images and sensor data captured during the movement of the robot 300, and for example, the start and return point A may be selected as a safe location to which the robot 300 is highly likely to return and/or a location that is easy for the robot 300 to move to the next location. The location to which the robot 300 is highly likely to return may be determined based on the conditions (material, space, smoothness, etc.) of the floor surface, the presence or absence of two or more nearby passages through which the mobile robot can move or the slope inclination, and the location that is easy for the robot 300 to move to the next location may be stairs for moving up or down.

In particular, in an example, when FIG. 7 shows the first floor and FIG. 8 shows the second floor higher than the first floor of FIG. 7 by one floor, the stairs 701-1 may be a trajectory connecting the first floor to the second floor and the stairs 711 may be a trajectory leading to the third floor. When capturing images for indoor map creation in the building including multiple floors, as the environment changes with the movement between floors, it may be difficult to match the images captured at each point or errors may occur. To solve this problem, the robot 71 may identify the location of the stairs and capture images at a shorter interval than the general scan interval when going up or down the stairs. In addition, because the absolute coordinates of the stairs in the building can be identified, the start point or end point of the closed-loop trajectory may be determined using the stairs as a reference point.

Referring further to FIG. 8, scanning is performed while moving to each of scan position Nos. 7 to 15, and the selection of the scan position may be determined according to at least one of stability, height (a higher place rather than a lower place) or brightness of the floor surface at the scan position. Aside from or along with this, the selection of the scan position may be determined according to the size and type of objects in the images captured at the previous scan position. For example, when an object in the direction toward No. 14 (in front) is recognized in the scan images captured at the position No. 13 and there is no newly added object when moving in the direction toward No. 14, the next scan position may be determined after moving a longer distance (8 meters in FIG. 8) than usual. The scan position may be determined as a location at which an unidentified object at the previous scan position is found. Meanwhile, the accuracy of object identification in the images acquired in real time may be reduced due to the influence of indoor illuminance, additional collapse, or external wind or light.

In this case, the robot according to an embodiment of the present disclosure may set a threshold for a change in environment (temperature, a change in the object within the image, a change in brightness) that newly occurs, and when the threshold for any one element among the set thresholds is exceeded, immediately stop moving and determine a location at which the movement was stopped as a new scan position.

In addition, when determining the scan position, it may be necessary to exclude an unrelated element to indoor map creation among external environmental factors. To this end, even when the aforementioned threshold is exceeded, the movement may not be stopped based on the type or location of the identified object. When another object in an object, for example, a window, or a brightness change in the window is found, whether to stop moving may be determined after additional state identification. When there is a large window and moving construction equipment is seen outside the window or light from recovery equipment enters the interior, it is necessary to ignore them.

In addition, referring to FIG. 8, a change of the planned movement direction of the robot (scan positions 7 to 15) is illustrated. Referring to FIG. 8, when the robot climbs the stairs 701-1, the robot may scan the surroundings at position 7 and determine any one direction toward scan position 15 or scan position 8. For example, when there are more cracks or a higher collapse risk at scan position 15, the robot may move in the direction of scan positions 7-15-14 so that the robot may first pass through the scan position 15. Additionally, location 77 is where the loop is closed in the modified movement trajectory, and when the ground at the corresponding location 77 is uneven or it is difficult to acquire the surrounding images at the corresponding location 77, loop closing and image synthesis may be performed based on the images acquired at position B as described above. In FIG. 8, the scan positions 7 to 15 do not refer to the absolute movement direction of the robot.

In addition, when selecting the start point A, the pose graph optimization unit 255 may determine a specific area within a predetermined close range based on location information of a unique object (an emergency exit sign) that is easy to identify in the surrounding images. Accordingly, the location information of the determined start point A may be transmitted to the robot 300 through the robot operation unit 251.

Meanwhile, as shown in FIG. 8, when setting the start point A, it is necessary to set the end point A by the first closed loop 10, but it may be difficult for the robot 300 to return to the initially set point during movement to form the closed loop (loop closing). For example, a sudden wall collapse or a falling object may become an obstacle.

The robot operation unit 251 according to an embodiment of the present disclosure may control the robot 300 to dynamically change the start point and end point to another start point and end point based on the surrounding environment. For example, the robot operation unit 251 controls the trajectory movement by setting the point A as the start point and end point of the first closed-loop trajectory 10, but when the robot 300 cannot go to the point A due to an obstacle or a structural change, the point B of which the relative location to the point A is clearly known may be determined as an alternative end point of the closed-loop trajectory, and the second closed-loop trajectory 20 may be optimized by the pose graph optimization unit 255.

Here, because the absolute coordinates of the points A and B are known, their relative displacement is calculated as a fixed value, and even when the robot 300 does not return to the point A, the pose graph optimization unit 255 may map at least part of the images and sensor data collected in the first closed-loop trajectory 10 to the second closed-loop trajectory 20 in which the image information and sensor data captured at the point B are optimized using the relative displacement value between A and B, and the precision map creation unit 257 may update the entire indoor map using the same, thereby maintaining the precision of the indoor map.

For example, referring to FIGS. 7 and 8, both the points A and B have emergency exits as the object whose absolute coordinates are known. Accordingly, the precision map creation unit 257 may perform additional updates of the indoor map based on the images and sensor data currently collected in the second closed-loop trajectory 20 by using the previous information of a part of the trajectory under the assumption that the robot 300 starts from the point A on the first closed-loop trajectory 10 and returns to the point A, although the robot 300 moves along the second closed-loop trajectory 20, by using the relative location difference between them.

In addition, the point B as the alternative end point is preferably selected as a nearby point that is present within at least a predetermined distance from the point A or where the environment of the point A may be included in the surrounding image. This is because when the location A is included in the surrounding image captured at the point B, precise positioning and mapping is achieved by relative difference correction.

The settings and constraints of each point as described above may be processed according to the condition settings of the map generation trajectory. To this end, the robot operation unit 251 may set each trajectory condition and command the robot 300 to move the position and collect sensor data according to the condition settings.

More specifically, the robot operation unit 251 may set the condition information of the first closed-loop trajectory corresponding to the first location A, wherein the condition information includes a condition for selecting, as the first location, a location to which the robot can return among nearby locations, and the location to which the robot can return may be determined based on at least one of the state information of the floor surface acquired from the sensor information of the robot, information associated with the presence or absence of two or more nearby passages through which the mobile robot can move, or slope information.

In addition, the condition information may include condition information for determining the first location as a specific area within a predetermined close range based on location information of a unique object that is easy to identify in the images among nearby locations, and when the robot cannot return to the first location due to an obstacle or a structural change, the condition information may include condition information for determining, as the alternative end point of the first closed-loop trajectory, the second location (point B) of which relative location information to the first location is identified and which is close to the first location within the predetermined distance.

Further, when the second location is determined as the alternative end point, the second map generation trajectory including the second closed-loop trajectory 20 of movement between the first location and the second location may be determined, and the precision map creation unit 57 may update the indoor map based on the images and sensor data collected in the second closed-loop trajectory by using the previously collected information of at least part of the first closed-loop trajectory where the robot starts from the first location and returns to the first location although the robot moves along the second closed-loop trajectory.

In addition, as described above, the second location is preferably set as a location at which relative difference correction is enabled because the environment of the first location is included in the surrounding image collected from the robot to produce the map.

Furthermore, in some embodiments, the condition information for determining the first closed-loop trajectory may further comprise a condition for selecting, as the first location, a returnable point among the surrounding positions. This returnable point may be determined based on at least one of: the condition of the floor surface obtained from the robot's sensor data, information indicating whether two or more passages allowing the movement of the robot exist in the surrounding environment, and slope inclination data. When returning to the first location becomes infeasible due to obstacles or structural changes, the condition information may further include relative position data with respect to the first location and a condition for selecting a second location, located within a predetermined distance, as an alternative endpoint of the first closed-loop trajectory. When the second location is determined as the alternative endpoint, the second map generation route may be configured as a second closed-loop trajectory connecting the first and second locations. Even in cases where the robot moves along the second closed-loop trajectory, the indoor map may be updated using previously collected data corresponding to at least a portion of the original first closed-loop trajectory—namely, the segment between departure from and return to the first location—thereby enabling efficient and precise map refinement even when route deviations occur.

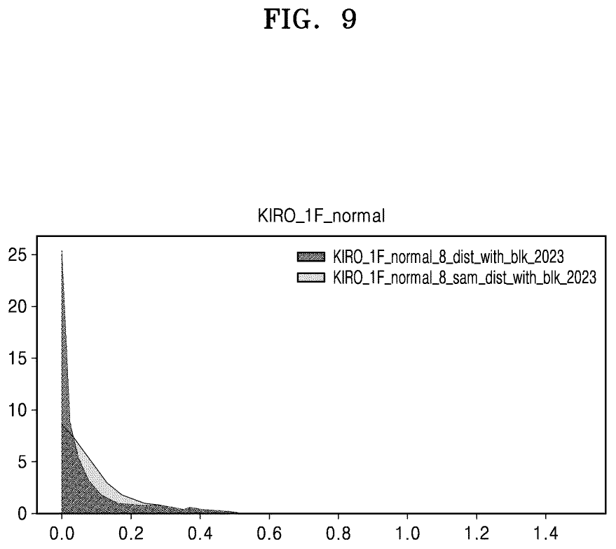

FIG. 9 is a diagram showing the accuracy test experimental results using an embodiment of the present disclosure.

Referring to FIG. 9, the performance of the open loop pipeline is shown in blue, and the performance of the closed loop pipeline according to an embodiment of the present disclosure is shown in yellow. The test was conducted to assess accuracy by comparing a map created through the BLK360 high-precision sensor with a 3D map created through each pipeline-based SLAM algorithm. As shown in FIG. 9, it can be seen that when the current estimate is properly corrected by the optimized local map, accumulated errors in odometry are removed, thereby improving the odometry performance and improving the overall performance.

The embodiments described hereinabove may be implemented, at least in part, in a computer program and recorded on a computer-readable recording medium. The computer-readable recording medium in which the program for embodying the embodiments is recorded includes any type of recording device in which computer-readable data is stored. Examples of the computer-readable recording medium include ROM, RAM, CD-ROM, magnetic tape, and an optical data storage device. Additionally, the computer-readable recording medium is distributed over computer systems connected via a network, and may store and execute a computer-readable code in a distributed manner. Additionally, a functional program, code and a code segment for realizing this embodiment will be easily understood by persons having ordinary skill in the technical field to which this embodiment belongs.

While the present disclosure has been hereinabove described with reference to the embodiments shown in the drawings, this is provided for illustration purposes only and it will be appreciated by those having ordinary skill in the art that a variety of modifications and variations may be made thereto. However, it should be noted that such modifications fall within the technical protection scope of the present disclosure. Therefore, the true technical protection scope of the present disclosure will be construed as including other implementations, other embodiments and the appended claims and their equivalents by the technical spirit of the appended claims.

What is claimed is:

1. A method for producing precise indoor maps using loop closing, performed by a computing device, the method comprising the steps of:
moving a robot to a first location, wherein the robot collects images and sensor data for precise map production by using a sensor module including at least one of a LiDAR sensor, an Inertial Measurement Unit (IMU) sensor or at least one vision sensor;
forming a first closed-loop trajectory with an optimized pose graph by odometry estimation from the first location to create a first map using the movement of the robot;
updating at least part of a second map generation trajectory and sensor data corresponding to a current trajectory of the robot by using at least one of trajectory information and sensor data of the first closed-loop trajectory; and
outputting an updated second map based on the updated second map generation trajectory and sensor data,
wherein the method further comprises the step of:
setting condition information of the first closed-loop trajectory corresponding to the first location,
wherein the condition information includes:
a condition for selecting a location to which the robot can return among nearby locations as the first location,
wherein the location to which the robot can return is determined based on at least one of state information of a floor surface acquired from the sensor information of the robot, information associated with presence or absence of two or more nearby passages through which the mobile robot can move, or slope information,
wherein the condition information includes:
when the robot cannot return to the first location due to an obstacle or a structural change, condition information for determining, as an alternative end point of the first closed-loop trajectory, a second location of which relative location information to the first location is identified, and which is close to the first location within a predetermined distance,
wherein when the second location is determined as the alternative end point, the second map generation trajectory including a second closed-loop trajectory of movement between the first location and the second location is determined, and
wherein the updating step includes the step of:
updating the indoor map based on the images and sensor data collected in the second closed-loop trajectory by using the previously collected information of at least part of the first closed-loop trajectory where the robot start from the first location and returns to the first location although the robot moves along the second closed-loop trajectory.

2. The method for producing precise indoor maps using loop closing according to claim 1,
wherein the updating step includes the step of:
performing pose graph optimization of the second map generation trajectory by using the at least one of the trajectory information and sensor data of the first closed-loop trajectory.

3. The method for producing precise indoor maps using loop closing according to claim 2, comprising the step of:
updating local map information and odometry estimation corresponding to the current trajectory of the robot by using local map information updated by the pose graph optimization of the second map generation trajectory.

4. The method for producing precise indoor maps using loop closing according to claim 2,
wherein the pose graph optimization of the second map generation trajectory includes:
loop closing optimization of optimizing an entire trajectory of the robot (300) along the first closed-loop trajectory, and smoothing optimization of re-optimizing at least part of a visited trajectory in the first closed-loop trajectory by using the information collected so far.

5. The method for producing precise indoor maps using loop closing according to claim 1, further comprising the step of:
setting the condition information of the first closed-loop trajectory corresponding to the first location,
wherein the condition information includes:
the condition for selecting the location to which the robot can return among nearby locations as the first location, and
wherein the location to which the robot can return is determined based on all the state information of the floor surface acquired from the sensor information of the robot, the information associated with presence or absence of two or more nearby passages through which the mobile robot can move, and the slope information.

6. The method for producing precise indoor maps using loop closing according to claim 5,
wherein the condition information includes:
condition information for determining the first location as a specific area within a predetermined close range based on location information of a unique object that is easy to identify in the images among nearby locations.

7. The method for producing precise indoor maps using loop closing according to claim 5,
wherein the condition information includes:
when the robot cannot return to the first location due to an obstacle or a structural change, condition information for determining, as an alternative end point of the first closed-loop trajectory, a second location of which relative location information to the first location are identified, and which is close to the first location within a predetermined distance.
